(19) United States
(12) Patent Application Publication
(10) Pub. No.: US 2016/0316288 A1
(43) Pub. Date: Oct. 27, 2016

(54) SPORT HEADPHONES

(71) Applicant: Harman International Industries, Incorporated, Stamford, CT (US)

(72) Inventor: Carlos MENDEZ ESTRADA, Tijuana (MX)

(21) Appl. No.: 15/133,594

(22) Filed: Apr. 20, 2016

Related U.S. Application Data
(60) Provisional application No. 62/150,613, filed on Apr. 21, 2015.

(51) Int. Cl. H04R 1/10

(52) U.S. Cl. CPC H04R 1/1008

(57) ABSTRACT

A collapsible headphone device may include a front member having a first member and a second member, an earpiece operably connected to a distal end of each of the first member and the second member, and a center member extending outwardly from the front member and pivotably connected to the first member and the second member, wherein the members are moveable between an expanded state and a collapsed state.

### CROSS-REFERENCE TO RELATED APPLICATIONS

This application claims the benefit of U.S. provisional application Ser. No. 62/150,613 filed Apr. 21, 2015, the disclosure of which is hereby incorporated in its entirety by reference herein.

### TECHNICAL FIELD

Embodiments disclosed herein generally relate to a sport headphone device.

### BACKGROUND

Headphones are often used by a user to listen to audio and are often worn during physical activity and exercise such as running, cycling, swimming, etc. Headphones may be used to receive instructions from a fitness instructor as well as to receive phone calls. Existing headphones may lack the flexibility, comfortability, and stability necessary to satisfy the wearer and can often be heavy and/or bulky.

### SUMMARY

A collapsible headphone device may include a front member having a first member and a second member, an earpiece operably connected to a distal end of each of the first member and the second member, and a center member extending outwardly from the front member and pivotably connected to the first member and the second member, wherein the members are moveable between an expanded state and a collapsed state.

A low-profile headphone device including a curved front member, an earpiece operably connected to each end of the front member, and a curved center member extending outwardly from a center of the front member and pivotably connected to the front member such that the center member is radially movable with respect the front member.

A low-profile headphone device may include a curved front member extending between two distal ends, an earpiece operably connected to each end of the front member, and a center member connected to the front member and extending outwardly generally perpendicular therefrom.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1A illustrates a perspective view of a headphone device in accordance with one embodiment;

FIG. 1B illustrates a front view of the headphone device of FIG. 1A;

FIG. 1C illustrates a side view of the headphone device of FIG. 1A;

FIG. 1D illustrates a rear view of the headphone device of FIG. 1A;

FIG. 2A illustrates a perspective view of a another headphone device in accordance with one embodiment;

FIG. 2B illustrates a front view of the headphone device of FIG. 2A;

FIG. 2C illustrates a side view of the headphone device of FIG. 2A;

FIG. 3A illustrates a perspective view of another headphone device in accordance with one embodiment;

FIG. 3B illustrates a front view of the headphone device of FIG. 3A;

FIG. 3C illustrates a side view of the headphone device of FIG. 3A;

FIG. 4A illustrates a perspective view of a frame of the headphone device of FIG. 2A in the process of being moved from an expanded state to a collapsed state; and

FIG. 4B illustrates a perspective view of a frame of the headphone device of FIG. 2A in a collapsed state.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein are sport headphone devices configured to be worn by a user during physical activity such as running, swimming, biking, hiking, etc. The headphone devices may include a low-profile headphone device configured to fit a user's head so as to minimize movement during the physical activity. Furthermore, the headphone devices may be configured to be worn underneath a headpiece such as a hat, helmet, swim cap, etc. The headphone device may be configured to be added or incorporated to the swim cap, helmet, etc.

The headphone devices may include one or more members configured to be arranged around the user's head. The members may form a T-like shape wherein in use a front member may extend across the user's forehead and extend from ear to ear. A center member may then extend generally perpendicular to the front member across and down a center of the user's head. An earpiece may be arranged on each end of the front member to deliver audio to the user's ear.

In one example, the front member may include first and second members pivotably connected to each other and to the center member. In use, the first and second members may extend from a pivot joint across the top of the user's forehead and may each include an earpiece arranged at an end thereof. In an extended state, the first and second members may be generally perpendicular to the center member. When not in use, the first and second members and the center member may move with respect to one another about the pivot joint so as to form a collapsed state. In one embodiment, the first and second members and the center member may align, one underneath the other, in order to form a compact, collapsible headphone device. This collapsible feature may be especially beneficial to cyclists, triathletes, etc., who may remove the headphone device during their activity and store the device in a pocket such as a rear jersey pocket, etc. The headphone device may be lightweight and unobtrusive to the user allowing for comfortable and secure wearing.

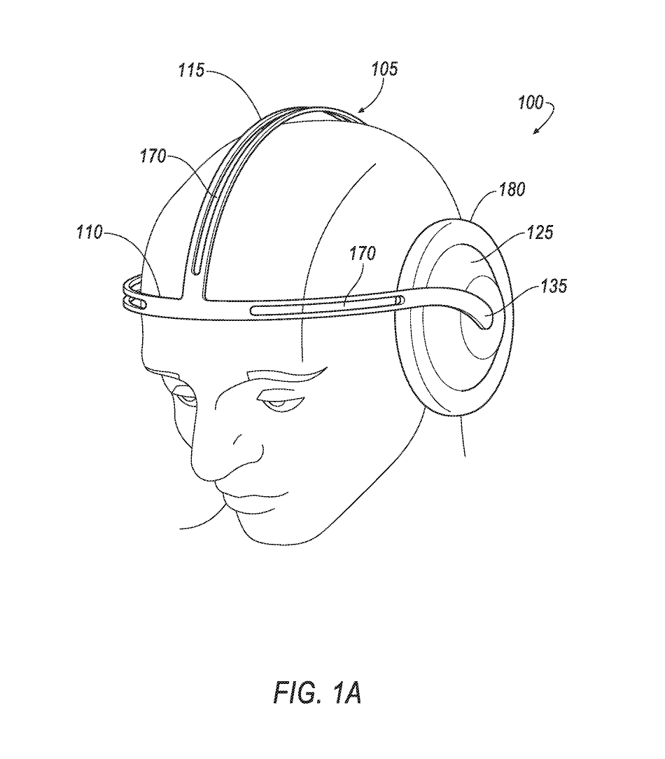

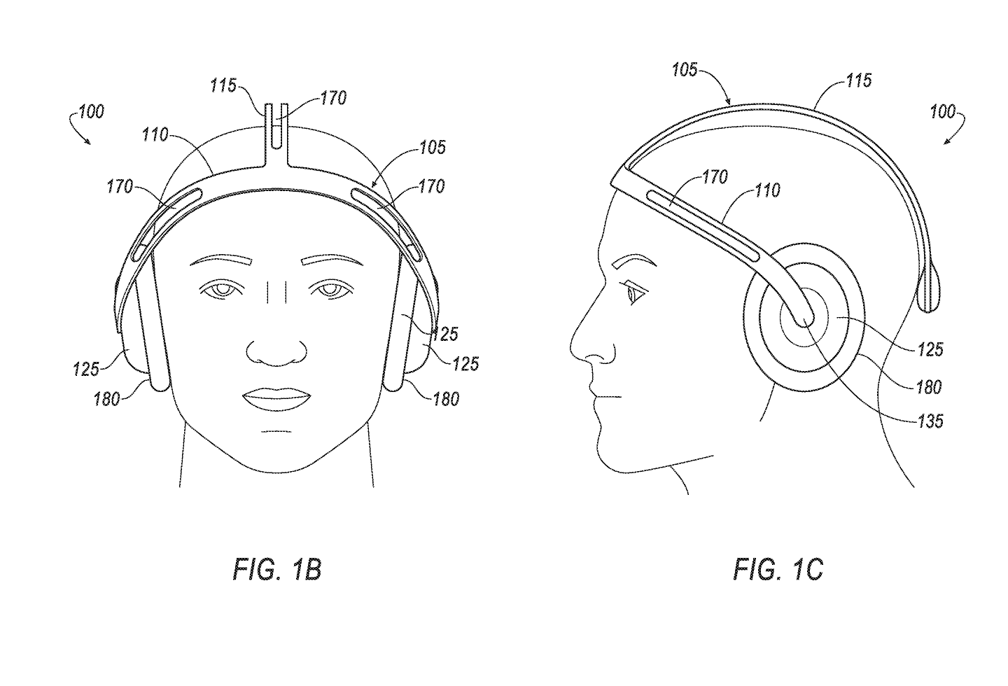

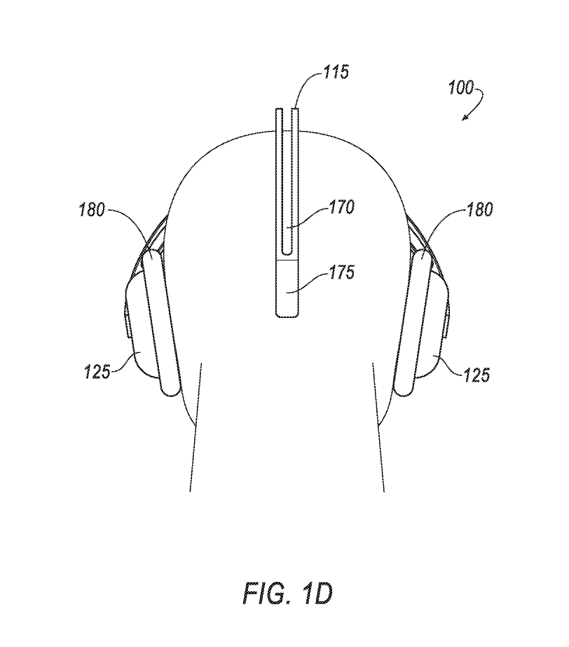

FIG. 1A illustrates a perspective view of a headphone device 100 in accordance with one embodiment. FIG. 1B illustrates a front view of the headphone device 100 of FIG. 1A and FIG. 1C illustrates a side view of the headphone device 100 of FIG. 1A. FIG. 1D illustrates a rear view of the headphone device 100. The headphone device 100 includes at least one frame 105 including a front member 110 and a center member 115. The frame 105 may be configured to be arranged on a user's head. When worn, the front member 110 may extend from ear to ear across a user's forehead. The center member 115 may extend generally perpendicular from the front member 110, forming a T-like shape, and may be configured to extend from the top of the user's head to the back of the user's head, just above the user's neck, as best shown in FIG. 1D. Of course, the frame 105 is not limited to the generally perpendicular configuration illustrated, and it is understood that the front member 110 and the center member 115 can have any relative orientation with respect to each other to allow for supporting of the frame 105 on a user's head.

The frame 105 may be formed from a single piece of material including the front member 110 and the center member 115. The frame 105 may be made of flexible or pliable material such as a plastic composition. In one example, the frame 105 may be made of a hard polymer material such as polyethylene, polypropylene, poly (vinyl chloride), and/or polystyrene, for example, which may be formed easily when heated and can be molded into a variety of shapes. The frame 105 and the members 110, 115 may also be made of glasses, elastomers, nano materials formed using molecular nanotechnology, etc. Other materials may also be used. The frame may be formed via injection molding, die-casting, etc.

The frame material may allow for easy cleaning of the headphones and the material may be water resistant or waterproof to permit use in non-dry conditions (e.g., swimming). The frame material may be resilient to also allow for flexibility and pliability with respect to the individual members 110, 115. When in use, the members 110, 115 may be configured to apply an inward compression on the user's head to aid in maintaining the headphone device 100 on the user's head. Upon placement on the user's head, the members 110, 115 may flex slightly outward to fit onto the head. Once in place, the members may retract back inwardly on the head in an effort to maintain placement and secure the headphone device 100 thereon.

The members 110, 115 may define one or more openings 170 extending therethrough configured to allow for air to circulate through the members 110, 115 to increase user comfort and decrease a weight of the members 110, 115. In one example, the openings 170 may be in the form of an elongated slot along the members, or any other suitable configuration, and may facilitate air flow there between while still permitting the members to be rigid and secured to the user's head.

The members 110, 115 may be configured to fit to a user's head so as to minimize movement of the headphone device 100 during rigorous physical activity. The members 110, 115 may have a curved, concave-like shape with a generally flat interior surface, allowing for a comfortable fit about the user's head. The front member 110 and the center member 115 may have differing curvatures to accommodate the varying curvatures of the user's head. For example, the front member 110 may have a smaller radius of curvature than that of the center member 115. Furthermore, the radius of curvature of the members 110, 115 may differ across each member. The center member 115, for example, may have a smaller radius of curvature at the portion closer to the user's neck than at the portion extending across the top of the user's head. As explained, the members 110, 115 may be flexible to allow for varying sizes of heads.

A cushion 175 may be arranged at a distal end of the center member 115 to provide comfort during use. The cushion 175 may positioned at a base of the user's head to provide comfort to the user as the center member 115 grips the user's head during use. The cushion 175 may be made of a foam material, latex, cotton, or any other soft and flexible material.

The front member 110 and/or the center member 115 may include an adjustment mechanism (not shown) allowing the length of the respective members 110, 115 to be altered to fit a specific user's head. In one example, the adjustment mechanism may include a telescoping feature, or other mechanism that allows for the length of each member to be adjusted.

An earpiece 125 may be arranged at each end 135 of the front member 110. Each earpiece 125 may house a speaker and an audio device (not shown) for audio playback at the speaker. The audio device may be integrated into the earpiece 125 and may also be a separate device configured to transmit an audio signal either via a hardwired connection such as a cable or wire as well as a wireless connection such as a cellular, wireless, or Bluetooth network, for example. The audio device may be a mobile device such as a cell phone, iPod, notebook, personal computer, media server, tablet device, E reader, etc. In the examples shown in FIGS. 1A-1D, the earpiece 125 may include on-ear headphones or over-ear headphones where the earpiece includes a seal 180 configured to be arranged on or around the user's ear. The seal 180 may provide for noise cancelation.

The headphone device 100 may include a microphone (not shown) configured to receive sound, or audio signals. These audio signals may include ambient noise as well as audible sounds and commands from the user. These audio signals may be used for signal processing, noise cancellation, etc. The headphone device 100 may also include a user interface (not shown) configured to receive commands or feedback from the user. Such commands may include various volume controls, skip commands, etc. Furthermore, the headphone device 100 may be powered by a rechargeable or replaceable battery. The headphone device 100 may also be powered by an alternating current (AC) wired power source such as a standard wall outlet.

The headphone device 100 may include a wireless transceiver (not shown) configured to receive or send wireless commands from an external device, such as a mobile device. The wireless commands may include commands initiated by a user at a mobile application to provide instructions for audio playback at the headphone device 100. In one example, the headphone device 100 may pair with a mobile device and may be configured to wirelessly receive audio signals and other commands from the mobile device. The headphone device 100 may also be configured to receive a wired input and communicate with an external device via a wired communication.

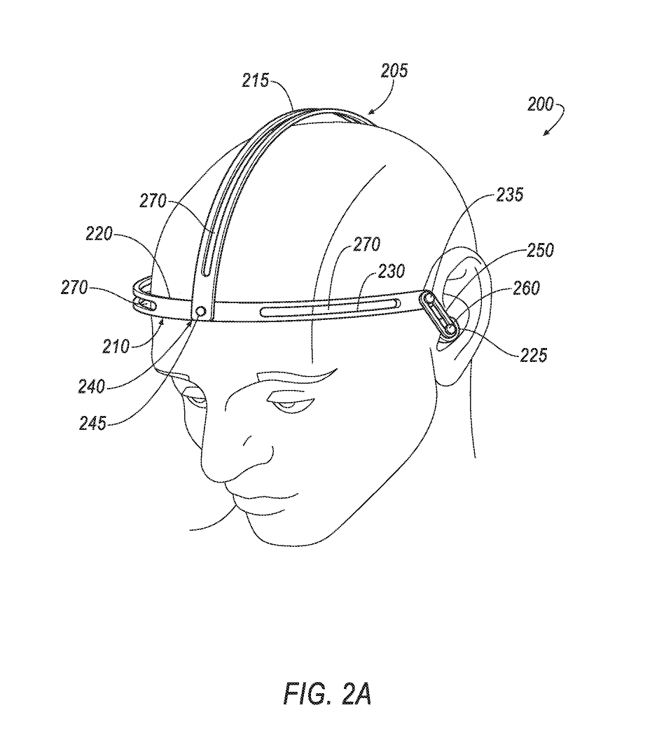

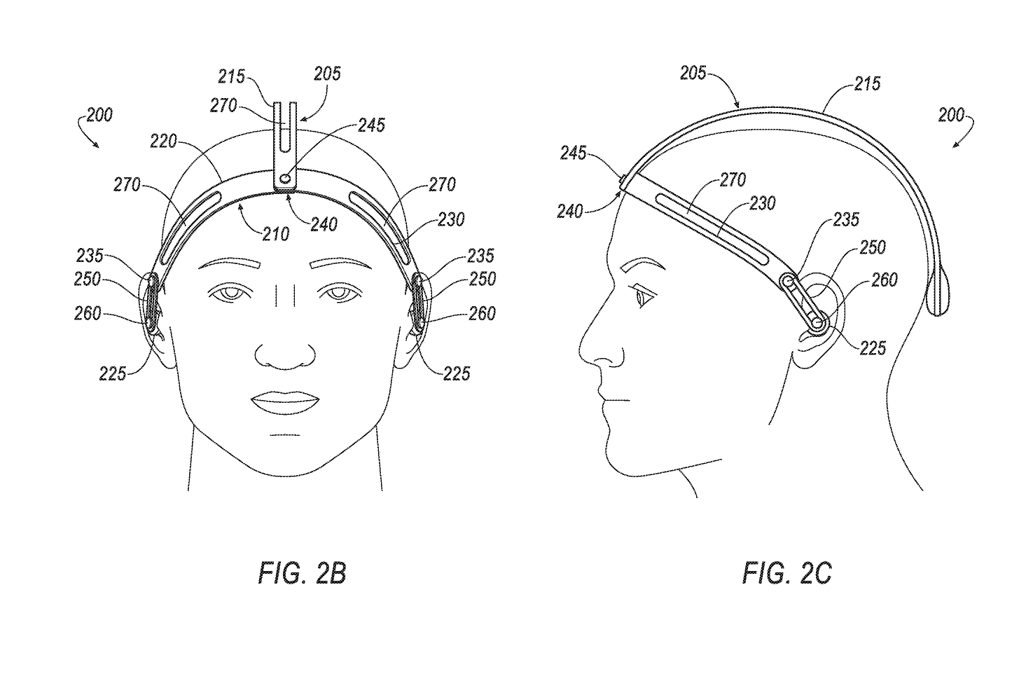

FIG. 2A illustrates a perspective view of another example headphone device 200. FIG. 2B illustrates a front view of the headphone device 200 of FIG. 2A, and FIG. 2C illustrates a side view of the headphone device 200 of FIG. 2A. Similar to FIGS. 1A-1D, the headphone device 200 may include a frame 205. The frame 205 may include a front member 210 and a center member 215, and each may have at least one opening 270 defined therein. In the examples shown in FIGS. 2A-2C, the front member 210 may include a first member 220 and a second member 230. The first member 220, second member 230, and the center member 215 may be pivotably connected at a member joint 240. When in use, the member joint 240 may be arranged at the top center of the user's forehead.

The first member 220, second member 230, and the center member 215 may each be radially movable or rotatable about the joint 240, or hinge. The joint 240 may include any number of mechanisms permitting rotation at the joint 240. In one example, each member may define a hole (not shown) configured to receive a pin 245. Upon alignment of each hole, the pin 245 may be extended there through, thus allowing each member 220, 230, 215 to rotate about the pin 245. The pin 245 may compress each of the members 220, 230, 215 against one another with enough force to maintain the radial position of the members during use. The joint 240, however, may permit radial movement of the members 220, 230, 215 in response to force being applied to the same. That is, force applied by the user may permit radial movement of the members 220, 230, 215 with minimal resistance to adjust or collapse the members. During non-use, the members 220, 230, 215 may be collapsed so the headphone device 200 may be easily stored.

In one example, two of the members 220, 230, 215 may be connected at a fixed connection (not shown) separate from the remaining member. For example, the first and second members 220, 230 may be pivotably connected to a fixed member whereby the first and second members may be radially movable at the fixed member. The center member 215 may be fixed to the fixed member and may be stationary with respect to the fixed member. Thus, the two movable members (e.g., the first and second members 220, 230) may be configured to align with the other non-movable member (e.g., the center member 215). That is, the first and second members 220, 230 may be configured to move radially while the center member 215 remains fixed.

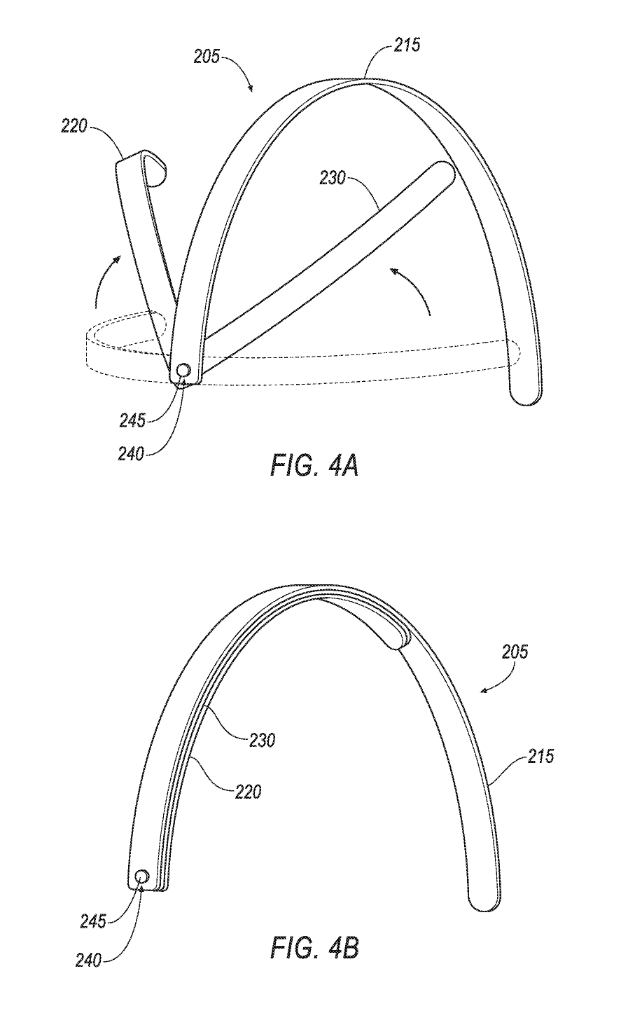

By permitting the members 220, 230, 215 to be movable with respect to the joint 240, the headphone device 200 may be adjusted to fit to a specific user's head. In a collapsed state, the members 220, 230, 215 may be arranged one on top of one another, as described with respect to FIG. 4 herein.

An earpiece 225 may be connected to a distal end 235 of the first and second members 220, 230. In one embodiment, a flexible support 250 is pivotably connected to each distal end 235. The flexible support 250 may be radially moveable with respect to the distal ends 235 of the front member 210 (i.e., first member 220 and second member 230). The flexible support 250 may also be pivotable at a distal end 260 thereof to allow for additional adjustment of the earpiece 225. Thus, the support 250 may provide for dual-pivot adjustment near the user's ear. Thus, once the headphone device 200 is placed on the user's head, the flexible support 250 may be used to further adjust the earpiece 225.

The support 250 may also include a support opening 280 configured to allow air to pass therethrough. The opening 280 may also allow the headphone device 200 to remain relatively lightweight while still maintaining its durability. The earpiece 225 may be an earpiece configured to fit within a user's ear canal such as an in-ear earpiece.

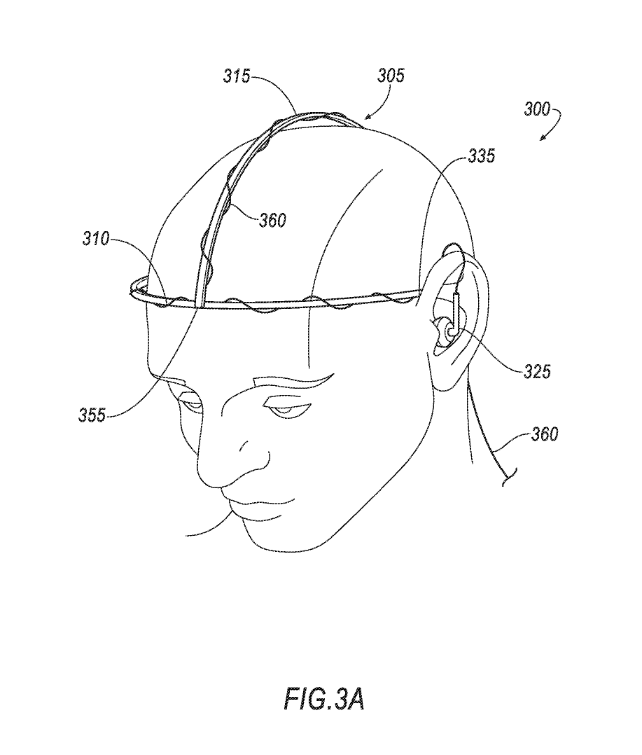

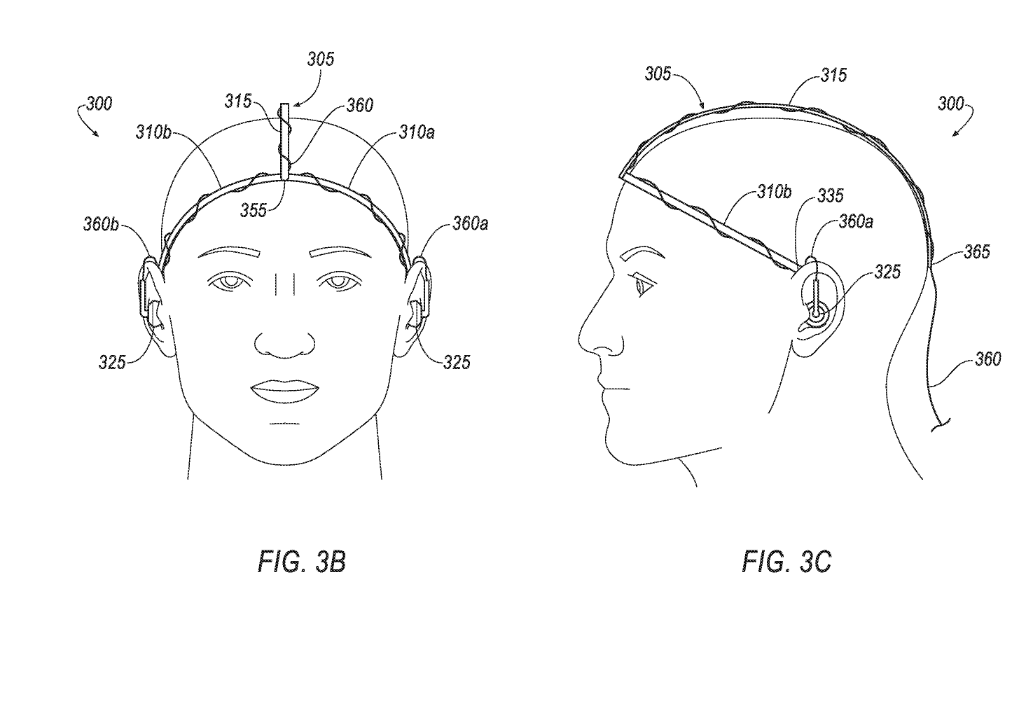

FIG. 3A illustrates a perspective view of another example headphone device 300. FIG. 3B illustrates a front view of the headphone device 300 of FIG. 3A, and FIG. 3C illustrates a side view of the headphone device 300 of FIG. 3A. Similar to FIGS. 2A-2C, the headphone device 300 may include a frame 305. The frame 305 may include a front member 310 and a center member 315 extending generally perpendicular from the front member 310. The front member 310 may be connected to the center member 315 via an attachment mechanism 355. The attachment mechanism may include a separate mechanism (not shown) or any mechanism configured to fix the center member 315 to the front member 310. In one example the members 310, 315 may be welded or soldered together. In another example, the attachment mechanism 355 may include a joint (not shown in FIGS. 3A-3C) similar to joint 240 of FIGS. 2A-2C. In this example, the center member 315 may be radially movable with respect to the front member 210 so that in a collapsed state, the center member 315 may be moved to align with a portion (e.g., one side) of the front member 210.

The headphone device 300 may include a wire 360 configured to provide audio signals to a speaker (not shown) within the earpiece 325. The wire 360 may be selectively connected to an external device such as a mobile device, iPad, tablet, etc. The wire 360 may be connected to the headphone device 300 at a distal end 365 of the center member 315. The wire 360 may be attached to or within the center member 315.

In the examples shown in FIGS. 3A-3C, an earpiece 325 may be arranged at a distal end 335 of the front member 310. The earpiece 325 may include an in-ear headphone similar to that described above with respect to FIGS. 2A-2C. The wire 360 may include a plurality of wires therein for providing various audio signals to the speaker. For example, as shown in FIGS. 3B and 3C, the wire 360 may include a right audio wire 360a and a left audio wire 360b. The right and left audio wires 360a, 360b may be split at the joint 340 and attached along or within a respective side of the front member 310. That is, the right audio wire 360a may travel along a right side 310a of the front member 310. The left audio wire 360b may travel along a left side 310b of the front member 310. The respective wires 360a, 360b may then be attached to the respective earpiece 325. As shown in the figures, the wire may extend from the distal end 335 to the earpiece 325.

It is to be understood that each of the examples described above may include some or all of the features described with respect to the other examples. For example, the headphone device 300 shown in FIGS. 3A-3C may include over-ear earpieces 125 as shown in FIGS. 1A-1D. Furthermore, as described above with respect to FIGS. 1A-1D, the first member 220, second member 230, and/or center member 215 as described with respect to FIGS. 2A-2C and the front member 310 and center member 315 as described with respect to FIGS. 3A-3C, may include an adjustment mechanism (not shown).

FIG. 4A illustrates the frame 205 of the headphone device 200 as described above with respect to FIGS. 2A-2C as it is being moved from an expanded state to a collapsed state. As explained, the members 220, 230, 215 may be rotatable at the joint 240. FIG. 4A illustrates the first and second members 220, 230 rotating inwards toward the center member 215. FIG. 4B illustrates the frame 205 in a collapsed state, which may include the members 220, 230, 215 positioned one on top of another. In the example shown in FIG. 4B, the first and second members 220, 230 may be arranged underneath the center member 215 when collapsed.

Although FIG. 4B illustrates the members 220, 230, 215 being in contact with one another in the collapsed state, the members 220, 230, 215 may also be spaced from one another. This may be a result of the radius of curvature of the first and second members 220, 230 being smaller than the center member 215. Thus, although the members 220, 230, 215 are shown as being in contact with each other, the members 220, 230, 215 may also align, or overlay, with one underneath another without contact due to a difference in the radius of curvature. In one example, the first and second members 220, 230 may be in contact with each other due to the fact that each may have substantially similar radius of curvature, while the first and second members 220, 230 may be spaced but still arranged ‘below’ or in-line with the center member 215.

As explained, the members 220, 230, 215 may be made of rigid materials and may form a relatively flat surface allowing the frame 205 to fit easily under various pieces of headwear. The resistance or tension on the members created by the joint 240 may be enough to maintain the members 220, 230 in a fixed radial position with respect to one another so that during use, the members 220, 230, 215 maintain their position on the user's head. The joint 240 may not create so much force that the members 220, 230, 215 cannot be moved about the joint when force is applied to each member (e.g., by a user's hands when collapsing the frame 205.) Thus, the headphone device 200 may be easy to expand and collapse while maintaining a low-profile and slim frame 205. The headphone device 200 may be made of lightweight materials and may be formed to adhere to the user's head. The headphone device 200 may be simple and relatively inexpensive to make.

In the collapsed state, as illustrated by way of example in FIG. 4B, the headphone device 200 may be easily stored for later use. The headphone device 200 may be stored in a jersey pocket, a cycle bag, swim bag, etc. When a user wishes to resume use of the headphone device 200, the members 220, 230, 215 may then be easily expanded to form a T-like shape and placed on the user's head. The user may then place a helmet, hat, or other headwear over the headphone device 200 and proceed to enjoy the benefits of the headphone device 200 while being able to wear the desired headwear.

Furthermore, the members 220, 230, 215 may be collapsible within the joint 240 via a telescoping mechanism, or any other mechanism. While the wire 360 in FIGS. 3A-3C may be shown to be arranged on the members 310, 315, it may be appreciated that the wires may be arranged within the members 310, 315. Additionally, any mechanism used to join the members together may provide for a smooth transition between the members so that the T-shaped device is as low profile as possible, providing for a comfortable surface for the user to wear the sport headphones for long periods of time. Although not show, a camera may be arranged within, on or near, the joint to capture images. For example, the camera may be a small camera configured to capture images during a bicycle ride, or other form a physical activity. A projector may also be included in or at the joint in order to project a display. In one example, the projector may project images onto a wall, panel or screen in front of the user to provide information or simulation to the user. Such simulations may include a video stream for simulating a bike ride.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A collapsible headphone device, comprising:
a front member having a first member and a second member;
an earpiece operably connected to a distal end of each of the first member and the second member; and
a center member extending outwardly from the front member and pivotably connected to the first member and the second member, wherein the members are moveable between an expanded state and a collapsed state.

2. The device of claim 1, further comprising a pin joint binding the first, second, and center members which permits radial movement of the first, second, and center members in response to an applied force.

3. The device of claim 1, wherein in the collapsed state, the first and second members align with the center member.

4. The device of claim 1, wherein in the expanded state, the center member is generally perpendicular to the first and second members.

5. The device of claim 1, wherein the first member, the second member, and the center member are each curved.

6. The device of claim 5, wherein a radius of curvature of the first and second members is different from a radius of curvature of the center member.

7. The device of claim 1, wherein at least one of the first, second and center members define at least one opening to increase airflow through the respective member.

8. The device of claim 1, further comprising a support pivotably connected to the distal end of each of the first and second members, wherein the earpiece is connected to a distal end of the support.

9. The device of claim 1, wherein the earpiece includes a seal configured to provide noise cancelation.

10. The device of claim 1, wherein the earpiece includes an in-ear earpiece.

11. The device of claim 1, wherein the center member includes a pad at a distal end thereof.

12. A low-profile headphone device, comprising:
a curved front member;
an earpiece operably connected to each end of the front member; and
a curved center member extending outwardly from a center of the front member and pivotably connected to the front member such that the center member is radially movable with respect the front member.

13. The device of claim 12, further comprising a pin joint binding the front and center members which permits radial movement of the front and center members in response to an applied force.

14. The device of claim 12, wherein at least one of the front and center members define at least one opening to increase airflow through the respective member.

15. The device of claim 14, wherein the earpiece includes a seal configured to provide noise cancelation.

16. The device of claim 14, wherein the earpiece is an in-ear earpiece.

17. A low-profile headphone device, comprising:
a curved front member extending between two distal ends;
an earpiece operably connected to each end of the front member; and
a center member extending generally perpendicular from the front member.

18. The device of claim 17, wherein at least one of the front and center members define at least one opening to increase airflow through the respective member.

19. The device of claim 17, wherein the center member includes a pad at a distal end thereof.

20. The device of claim 17, wherein a radius of curvature of the front members is different from a radius of curvature of the center member.
